(19) United States
(12) Patent Application Publication
(10) Pub. No.: US 2004/0256825 A1
(43) Pub. Date: Dec. 23, 2004

(54) Steerable suspension system having composite axle beam

(76) Inventors: Thomas N. Chalin, Fairview, TX (US); Cully B. Dodd, McKinney, TX (US); Herbert D. Hudson, McKinney, TX (US)

Correspondence Address: KONNEKER & SMITH P. C., 660 NORTH CENTRAL EXPRESSWAY, SUITE 230, PLANO, TX, 75074, US

(21) Appl. No.: 10/602,457

(22) Filed: Jun. 23, 2003

(51) Int. Cl. B62D 7/18

(52) U.S. Cl. 280/93.512

(57) ABSTRACT

A steerable suspension system having a composite axle beam. In a described embodiment, a suspension system includes an axle assembly which has an axle beam made of composite material. King pin receivers may be formed in devices attached at opposite ends of the axle beam. The devices may be made of metal or composite material. The king pin receivers may alternatively be integrally formed with the axle beam.

### BACKGROUND

The present invention relates generally to vehicle suspension systems and, in an embodiment described herein, more particularly provides a steerable suspension system having a composite axle beam.

It is increasingly important for truck and trailer suspension systems to be made lighter and have increased load-carrying capacities. This is due, in part, to increased fuel costs and other costs of transporting goods by wheeled vehicles. By making the vehicle lighter, less fuel is consumed. By increasing the load-carrying capacity, more cargo may be transported by an individual vehicle.

It is known to fabricate suspension system components out of laminated material to decrease the weight of the components. However, prior methods of constructing these components are seen to be unsatisfactory, since they are very time-consuming and labor-intensive. One example is described in U.S. Pat. No. 5,788,263 (the entire disclosure of which is incorporated herein by this reference).

From the foregoing, it can be seen that it would be quite desirable to provide improved methods of constructing suspension systems having reduced weight and increased load-carrying capacities.

### SUMMARY

In carrying out the principles of the present invention, in accordance with an embodiment thereof, a steerable suspension system is provided which includes an axle assembly having an axle beam made of composite material.

The axle beam may be separately formed from king pin receivers attached at opposite ends of the axle beam. The king pin receivers may be included in devices attached at the axle beam ends. The devices may be made of attached metal plates, or they may be made of composite material. The devices may also include pivoting arm attachments, and axle seats complementarily shaped relative to the axle beam.

The devices may be made of a molded composite material. The king pin receiver, axle seat and pivoting arm attachment may be integrally formed in each device. The devices may include provisions for attaching multiple pivoting arms to each device, for use in a parallelogram-type suspension system. The devices may be integrally formed with the axle beam.

The axle beam may be generally tubular in shape. A reinforcement may be used to span an interior space of the axle beam at a location where a pivoting arm attachment is fastened to the axle beam. A fastener may extend through the reinforcement.

These and other features, advantages, benefits and objects of the present invention will become apparent to one of ordinary skill in the art upon careful consideration of the detailed description of representative embodiments of the invention hereinbelow and the accompanying drawings.

### BRIEF DESCRIPTION OF THE DRAWINGS

FIG. 1 is an isometric view of an axle assembly in a first suspension system embodying principles of the present invention;

FIG. 2 is an isometric view of an axle assembly in a second suspension system embodying principles of the present invention;

FIG. 3 is an isometric view of an axle assembly in a third suspension system embodying principles of the present invention;

FIG. 4 is an elevational view of the axle assembly in the third suspension system; and

FIG. 5 is an enlarged cross-sectional view of a portion of the third suspension system, taken along line 5-5 of FIG. 4.

### DETAILED DESCRIPTION

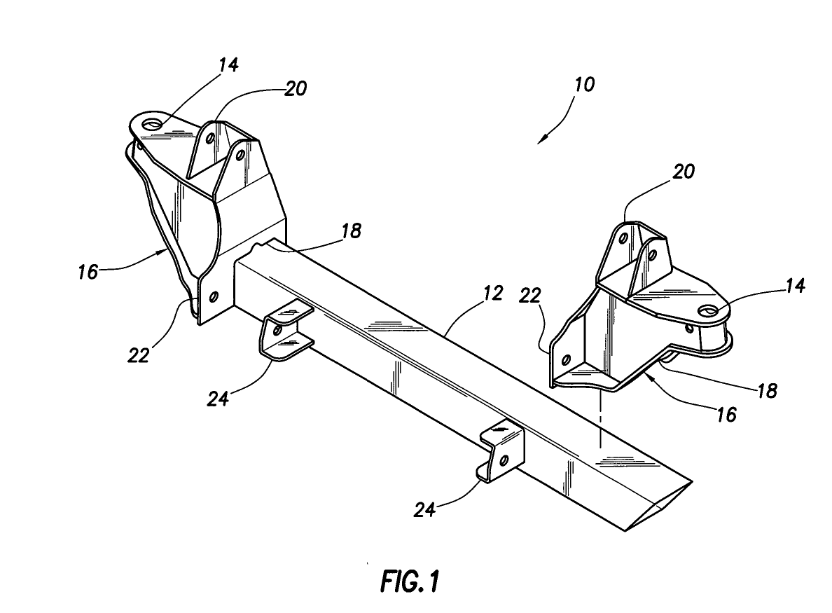

Representatively illustrated in FIG. 1 is an axle assembly 10 of a suspension system which embodies principles of the present invention. In the following description of the axle assembly 10 and other apparatus and methods described herein, directional terms, such as “above”, “below”, “upper”, “lower”, etc., are used only for convenience in referring to the accompanying drawings. Additionally, it is to be understood that the various embodiments of the present invention described herein may be utilized in various orientations, such as inclined, inverted, horizontal, vertical, etc., and in various configurations, without departing from the principles of the present invention.

The axle assembly 10 is preferably utilized in a steerable suspension system of the type described in U.S. Pat. No. 5,865,452, the entire disclosure of which is incorporated herein by this reference. That is, the unillustrated remainder of the suspension system of FIG. 1 is preferably the same as, or substantially similar to, that described in U.S. Pat. No. 5,865,452. The accompanying drawings, the descriptions thereof below and the incorporated U.S. Pat. No. 5,865,452 relate to parallelogram-type suspension systems, but it is to be clearly understood that other types of suspension systems may embody principles of the invention.

In one unique aspect of the invention, the axle assembly 10 includes an axle beam 12 made of a composite material. As used herein, the term “composite material” is used to indicate a material consisting of two or more constituents, insoluble in one another, which are combined to form the material possessing certain properties not possessed by the individual constituents. Examples of composite materials include glass or carbon fibers in a resin matrix, etc.

The axle beam 12 is preferably generally tubular in shape, having a hollow interior, and is fabricated using a process known to those skilled in the art as “pultrusion”. However, other shapes and other fabrication methods, such as laminating, molding, etc., may be used in keeping with the principles of the invention.

In another unique aspect of the invention, king pin receivers 14 are attached at each end of the axle beam 12. The king pin receivers 14 are configured for receipt of a conventional king pin therein for rotational attachment of a wheel spindle mounting yoke thereto. Such a spindle yoke is described and illustrated in the incorporated U.S. Pat. No. 5,865,452.

In yet another unique aspect of the invention, the king pin receivers 14 are included in devices 16 attached at opposite ends of the axle beam 12. To facilitate such attachment, each device 16 includes an axle seat 18 complementarily shaped relative to an outer side surface of the axle beam 12. The devices 16 may be attached to the axle beam 12 by adhesively bonding the axle seats 18 to the outer side surface of the axle beam 12, although other attachment methods may be used, if desired.

Each of the devices 16 further includes an attachment 20 for a pivoting arm or beam, such as a conventional trailing arm. As depicted in FIG. 1, the attachments 20 are brackets having openings for receiving fasteners for pivot bushings therein, but other types of attachments may be used, if desired.

A portion 22 of another pivoting arm attachment is preferably included in each device 16, with another portion 24 of each pivoting arm attachment being secured to the axle beam 12. Thus, a pivoting arm is attached to each pair 22, 24 of the attachment portions. As with the attachments 20 described above, the attachment portions 22, 24 are brackets having openings for receiving fasteners for pivot bushings therein, but other types of attachments may be used, if desired.

Of course, the portions 22, 24 could be otherwise positioned, without departing from the principles of the invention. For example, both portions 22, 24 could be included in each device 16 (as in the attachment 20), or they could both be attached directly to the axle beam 12. The attachment portions 24 may be made of composite material, and may be adhesively bonded to the axle beam or integrally formed therewith as a single piece.

As depicted in FIG. 1, each device 16 is made up of connected metal plates. The metal plates may be made of steel, aluminum, or another metal or metal alloy. The metal plates are preferably welded together to form the devices 16, although other fabrication methods may be used in keeping with the principles of the invention.

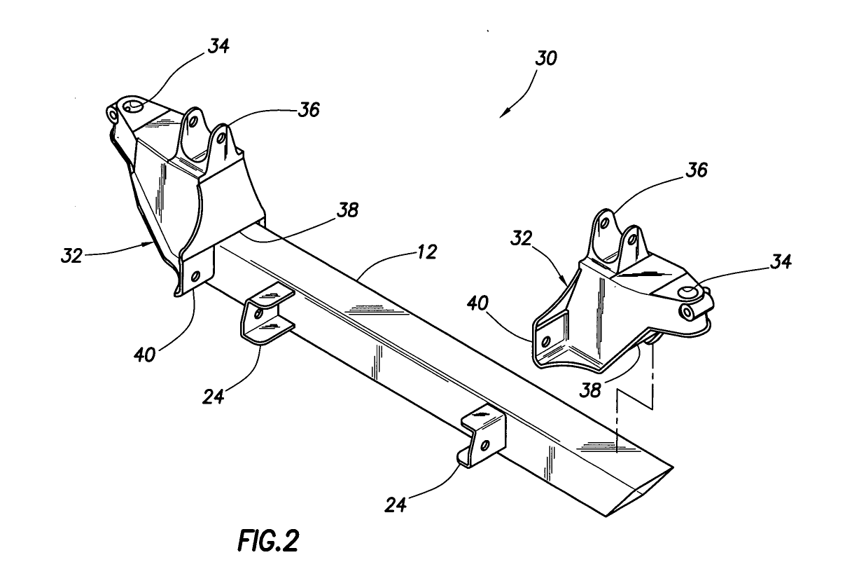

An example of another fabrication method is found in the embodiment of the invention representatively illustrated in FIG. 2. This figure depicts an axle assembly 30 which includes the axle beam 12 described above. Attached at each opposite end of the axle beam 12 is a device 32, each of which includes a king pin receiver 34, a pivoting arm attachment bracket 36, an axle seat 38 and a portion 40 of another pivoting arm attachment bracket.

One significant difference between the devices 32 depicted in FIG. 2 and the devices 16 depicted in FIG. 1 is that the devices 32 are made of a composite material. The composite material of which the devices 32 are made may be the same as the composite material of which the axle beam 12 is made, or a different composite material may be used. Since the devices 32 have relatively complex shapes, they are preferably fabricated by a molding process, rather than the pultrusion process used for the axle beam 12. However, other fabrication processes may be used without departing from the principles of the invention.

The devices 32 are preferably fabricated as a single piece each. That is, the king pin receiver 34, pivoting arm attachment 36, axle seat 38 and pivoting arm attachment portion 40 are integrally formed at the same time in each device 32 in the molding process. However, any of these elements may be separately formed in keeping with the principles of the invention.

Preferably, the composite material wraps about the king pin receiver 34 in each device 32. A sleeve or bushing, etc. may be used to line the king pin receiver 34 to prevent premature wear or other damage to the composite material about the king pin receiver, if desired. The sleeve, bushing, etc. may be made of metal or another wear resistant material.

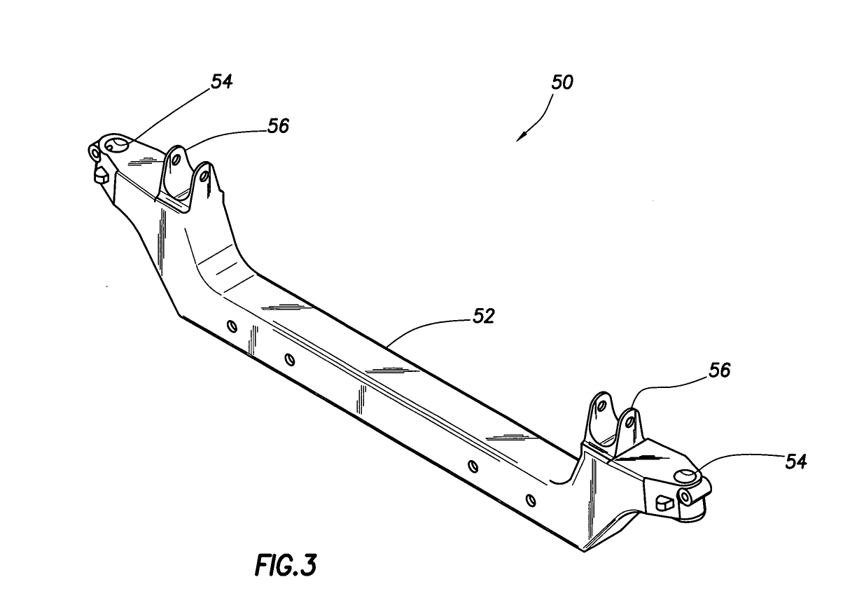

Instead of attaching the devices 32 at opposite ends of the axle beam 12, the elements of the devices could be formed directly on opposite ends of the axle beam. Representatively illustrated in FIG. 3 is another axle assembly 50 which utilizes this concept. In the axle assembly 50, the axle beam 52, king pin receivers 54 and pivoting arm attachments 56 are integrally formed of composite material. That is, the axle assembly 50 as depicted in FIG. 3 is fabricated as a single piece at one time, such as by molding, although other fabrication methods may be used, if desired.

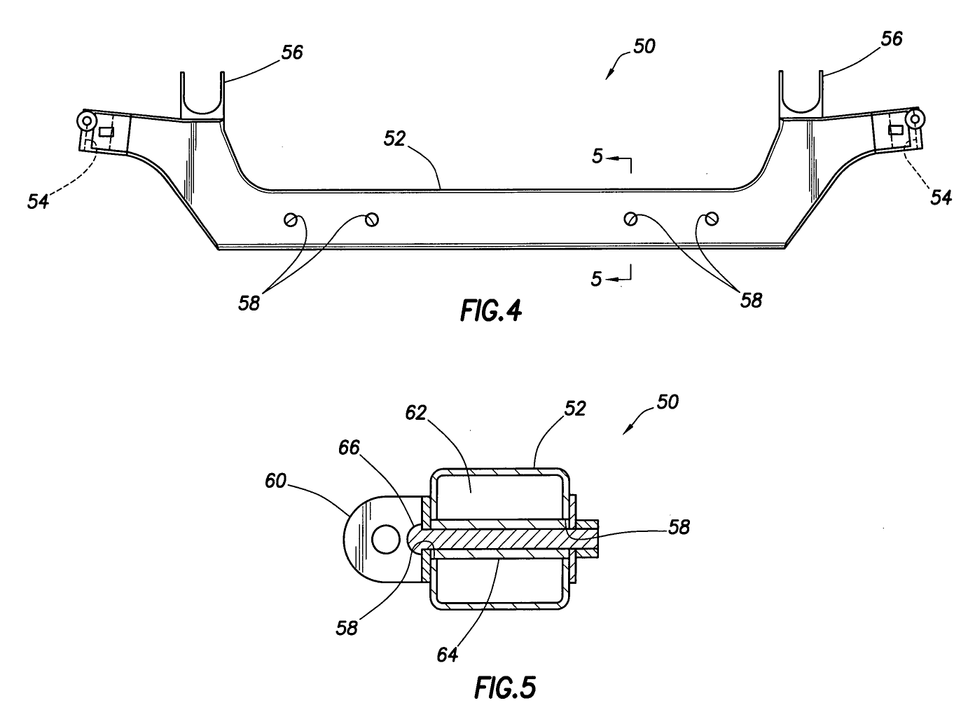

An elevational view of the axle assembly 50 is shown in FIG. 4. Note that attachments are not illustrated in FIG. 4 for attaching lower pivoting arms to the axle beam 52. Instead, FIG. 4 shows mounting holes 58 for attaching brackets to the axle beam 52.

In FIG. 5 an enlarged cross-section of the axle assembly 50 is illustrated, taken along line 5-5 of FIG. 4. In this view, a manner of mounting a pivoting arm attachment or bracket 60 to the axle beam 52 is shown.

If the axle beam 52 has a hollow interior space 62 (for example, if the axle beam is generally tubular shaped), then a sleeve or other reinforcement 64 may be used to bridge the gap between the holes 58 in opposing side walls of the axle beam. As depicted in FIG. 5, the reinforcement 64 extends completely through the axle beam 52 and is received in the holes 58.

A fastener 66 extends through the bracket 60, through one of the holes 58, through the reinforcement 64 and through another of the holes 58. By tightening or otherwise securing the fastener 66, the bracket 60 is mounted to the axle beam 52. The reinforcement 64 prevents the axle beam 52 opposing side walls from deflecting inward when the fastener 66 is secured.

Of course, a person skilled in the art would, upon a careful consideration of the above description of representative embodiments of the invention, readily appreciate that many modifications, additions, substitutions, deletions, and other changes may be made to these specific embodiments, and such changes are contemplated by the principles of the present invention. Accordingly, the foregoing detailed description is to be clearly understood as being given by way of illustration and example only, the spirit and scope of the present invention being limited solely by the appended claims and their equivalents.

What is claimed is:

1. A steerable suspension system, comprising:
an axle assembly including an axle beam made of composite material, and a king pin receiver attached at an end of the axle beam.

2. The steerable suspension system according to claim 1, wherein the king pin receiver is a portion of a device attached at the end of the axle beam, the device being formed separately from the axle beam prior to being attached to the axle beam.

3. The steerable suspension system according to claim 2, wherein the device is made of composite material.

4. The steerable suspension system according to claim 2, wherein the device is made of metal.

5. The steerable suspension system according to claim 2, wherein the device includes an axle seat complementarily shaped relative to the axle beam.

6. The steerable suspension system according to claim 5, wherein the axle seat is bonded to the axle beam.

7. The steerable suspension system according to claim 2, wherein the device includes a first attachment for a first pivoting arm.

8. The steerable suspension system according to claim 7, wherein the device further includes at least a portion of a second attachment for a second pivoting arm.

9. The steerable suspension system according to claim 2, wherein the device is constructed of attached metal plates.

10. The steerable suspension system according to claim 2, wherein the device is constructed of molded composite material.

11. The steerable suspension system according to claim 10, wherein the device molded composite material is wrapped about the king pin receiver.

12. The steerable suspension system according to claim 2, wherein the device includes a pivoting arm attachment, and an axle seat complementarily shaped relative to the axle beam, and wherein the king pin receiver, axle seat and pivoting arm attachment are integrally formed in the device.

13. The steerable suspension system according to claim 1, wherein the axle beam has at least a portion of an attachment for a pivoting arm attached to the axle beam.

14. The steerable suspension system according to claim 13, wherein the pivoting arm attachment includes a reinforcement spanning an interior of the axle beam.

15. The steerable suspension system according to claim 14, wherein a fastener for the pivoting arm attachment extends through the reinforcement.

16. The steerable suspension system according to claim 1, wherein the king pin receiver is made of composite material.

17. The steerable suspension system according to claim 16, wherein the axle assembly further includes a pivoting arm attachment made of composite material.

18. The steerable suspension system according to claim 17, wherein the axle beam, king pin receiver and pivoting arm attachment are integrally formed.

19. The steerable suspension system according to claim 17, wherein the axle beam, king pin receiver and pivoting arm attachment are molded as a single piece.
